(19) United States
(12) Patent Application Publication
(10) Pub. No.: US 2007/0112288 A1
(43) Pub. Date: May 17, 2007

(54) VIBRATOR

(75) Inventor: Tsung Kun KUO, Shenzhen City (CN)

Correspondence Address: Eric Chan, 42 Pin Oaks Drive, Phoenixville, PA, 19460, US

(73) Assignee: CHENGTAI RUBBER CO., LTD., SHENZHEN CITY (CN)

(21) Appl. No.: 11/556,179

(22) Filed: Nov. 3, 2006

(30) Foreign Application Priority Data
Nov. 3, 2005 (CN) 200520066649.X

(51) Int. Cl. A61H 1/00; A61H 1/02

(52) U.S. Cl. 601/16

(57) ABSTRACT

A vibrator in accordance with a preferred embodiment includes a motor, a power supply for driving the motor, a crankshaft linked to the motor and a coating layer at least coating the crankshaft. The coating layer includes a surface layer made of silicone rubber and a silica gel filled in the surface layer. An electric heating wire is engaged in the silica gel and conductively connected to the power supply. In the embodiment, the motor drives the crankshaft to rotate. The coating layer is twisted under rotation of the crankshaft to have the vibrator in vibration. The silica gel can conduct heat generated by the electric heating wire to a user. In comparison with most of current vibrators, this vibrator is simple, stable, convenient and warm, and accordingly very competitive in market.

### BACKGROUND OF THE INVENTION

The present invention relates to articles for use, and more particularly to a vibrator.

Generally, a vibrator vibrates by means of a cam installed therein. The cam rotates when driven by a motor, going along with a vibration of the vibrator to massage a part of human body. However, such vibrator has a complex configuration and consumes excessive electric power. Additionally, rubber is universally used in the vibrators as contacting portions which directly contact human body. Rubber has an adiabatic character, and can not sufficiently incorporate a heat-generating device to render the vibrators warm. As a result, the vibrators are always cool and uncomfortable.

### BRIEF SUMMARY OF THE INVENTION

Accordingly, what is needed is a vibrator having a simple configuration and a warm effect.

A vibrator in accordance with a preferred embodiment comprises a motor, a power supply for driving the motor, a crankshaft linked to the motor and a coating layer at least coating the crankshaft.

Further, the coating layer comprises a surface layer made of silicone rubber and a silica gel filled in the surface layer. An electric heating wire is engaged in the silica gel and conductively connected to the power supply.

Furthermore, the crankshaft is elongated, and wrapped by a protective sleeve at an end thereof linked to the motor.

Additionally, the vibrator further comprises a handle extended from an end of the coating layer, and the power supply is accommodated in the handle.

In the embodiment, the motor drives the crankshaft to rotate. The coating layer is twisted under rotation of the crankshaft to have the vibrator in vibration. The silica gel accommodated in the surface layer can conduct heat generated by the electric heating wire to a user. In addition, the touch feeling of the silica gel is good enough to comfort the user.

Summarily, in comparison with most of current vibrators, this vibrator is simple, stable, convenient and warm, and can comfort the users. Therefore, this vibrator will be very competitive in market.

Other advantages and novel features of the present invention will become more apparent from the following detailed description when taken in conjunction with the accompanying drawings, in which:

### BRIEF DESCRIPTION OF THE DRAWINGS

FIG. 1 is a cross-sectional view of a vibrator in accordance with a preferred embodiment of the present invention.

### DETAILED DESCRIPTION OF THE INVENTION

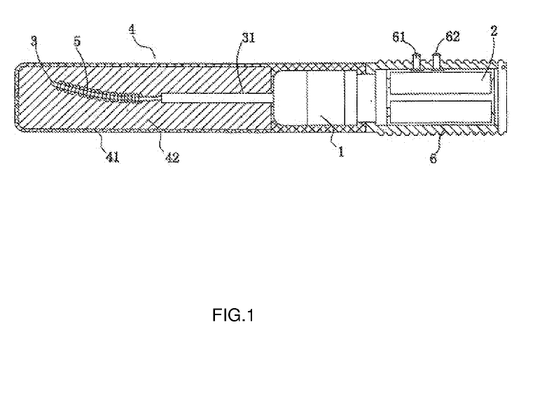

Referring to FIG. 1, the vibrator of the preferred embodiment comprises a motor 1, a power supply 2, a crankshaft 3, a coating layer 4, an electric heating wire 5 and a handle 6.

The power supply 2 is connected to the motor 1 via lead wires so that the power supply offers power to the motor 1 to operate the motor 1.

The crankshaft 3 is linked with output of the motor 1 so that the motor 1 drives the crankshaft 3. The crankshaft 3 is an elongated rod and has a crooked axial, such that the coating layer 4 is twisted under rotation of the crankshaft 3. The crankshaft 3 is wrapped by a protective sleeve 31 at an end thereof linked to the motor 1 to ensure a normal operation thereof.

The coating layer 4 comprises a surface layer 41 and a silica gel 42 contained in the surface layer 41. The surface layer 41 is made of a nontoxic material having high-temperature resistance, such as silicone rubber. The surface layer encloses a chamber. The silica gel 42 is filled in the chamber by perfusion. The electric heating wire 5 is engaged in the silica gel 42 and conductively connected to the power supply 2. The silica gel 42 is a heat conductive material; therefore, heat generated by the electric heating wire 5 can be conducted by the silica gel 42 to a user. The touch feeling of the silica gel 42 is good enough to comfort the user.

The handle 6 of the embodiment is extended from an end of the coating layer 42. The handle 6 defines a room therein, for accommodating batteries functioned as the power supply 2. The handle 6 is preferred to be provided with a cover for facilitating installation of the batteries therein. The handle 6 may be individually manufactured or integrally formed with the coating layer 42. The handle 6 facilitates users to hold the vibrator. The handle 6 is provided a switch 61 to control the motor 1 and a switch 62 to control the electric heating wire 5.

In use of the vibrator, the handle 6 is held and both or one of the switches 61, 62 are opened in accordance with the requirements to operate the vibrator. It is convenient for users.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vibrator comprising a motor (1), a power supply (2) for driving the motor (1), a crankshaft (3) linked to the motor (1) and a coating layer (4) at least coating the crankshaft (3).

2. The vibrator as claimed in claim 1, wherein the coating layer (4) comprises a surface layer (41) made of silicone rubber and a silica gel (42) filled in the surface layer (41), and wherein an electric heating wire (5) is engaged in the silica gel (42) and conductively connected to the power supply (2).

3. The vibrator as claimed in claim 1, wherein the crankshaft (3) is elongated and wrapped by a protective sleeve (31) at an end thereof linked to the motor (1).

4. The vibrator as claimed in claim 3, further comprising a handle (6) extended from an end of the coating layer (42), and wherein the power supply (2) is accommodated in the handle (6).

5. The vibrator as claimed in claim 1, wherein the handle (6) is provided a switch (61) to control the motor (1) and an additional switch (62) to control the electric heating wire (5).
